(19) United States
(12) Patent Application Publication
(10) Pub. No.: US 2012/0120548 A1
(43) Pub. Date: May 17, 2012

(54) CAPACITOR ASSEMBLY

(75) Inventor: Yoshinobu Hasuka, Toyota-shi (JP)

(73) Assignee: TOYOTA JIDOSHA KABUSHIKI KAISHA, Toyota-shi (JP)

(21) Appl. No.: 13/387,641

(22) PCT Filed: Jun. 16, 2010
(86) PCT No.: PCT/IB2010/001447

§ 371 Date: Jan. 27, 2012

(30) Foreign Application Priority Data
Jul. 30, 2009 (JP) 2009-177450

(51) Int. Cl. H01G 4/38

(52) U.S. Cl. 361/329

(57) ABSTRACT

A capacitor apparatus includes eight capacitor elements connected in parallel to an alternating-current current source. The impedance of a bus bar between the (j+1)th (j is 1 to 6) capacitor element and the (j+2)th capacitor element from a connecting terminal is (j+1) times the impedance of the bus bar between the first capacitor element and the second capacitor element from the connecting terminal. The impedance of the bus bar between the (j+1)th capacitor element and the (j+2)th capacitor element from a connecting terminal is (j+1) times the impedance of the bus bar between the first capacitor element and the second capacitor element from the connecting terminal.

### BACKGROUND OF THE INVENTION

1. Field of the Invention

The invention relates to a capacitor apparatus that includes a plurality of capacitor elements that are connected in parallel to an electric current source.

2. Description of the Related Art

There is a known capacitor apparatus that includes a plurality of capacitor elements that are connected in parallel to an electric current source. In such a capacitor apparatus, if variations occur among the electric currents that flow through the capacitor elements and overcurrent flows through one or more of the capacitor elements, failure is caused to the one of more capacitor elements. Therefore, it is demanded to restrain variations among the electric currents that flows through the capacitor elements. To meet this demand, for example, Japanese Patent Application Publication No. 9-320891 (JP-A-9-320891) proposes that in a capacitor apparatus, a plurality of capacitors are parallelly connected so that their wiring inductances are equal, and input/output-purpose terminals are led out from diagonally opposite positions in the foregoing parallel connection circuit, and are connected to another circuit, and the circuit constants of the individual capacitors with respect to the connection terminals are made equal.

However, it has been found that in the technology described in Japanese Patent Application Publication No. 9-320891 (JP-A-9-320891), variations occur among the electric currents that flow through the capacitor elements, due to influence of resonance current.

### SUMMARY OF THE INVENTION

In view of the foregoing problem, the invention provides a capacitor apparatus which includes a plurality of capacitor elements that are connected in parallel to an electric current source, and which restrains variations among the currents that flow through the capacitor elements.

According to one aspect of the invention, there is provided a capacitor apparatus that includes: n number of capacitor elements each of which has a first electrode and a second electrode, where n is an integer that is greater than or equal to three; a first electroconductive member to which the first electrodes of the n number of capacitor elements are connected, wherein the first electrodes of the n number of capacitor elements connected to the first electroconductive member are spaced from each other in a predetermined direction; a second electroconductive member to which the second electrodes of the n number of capacitor elements are connected, wherein the second electrodes of the n number of capacitor elements connected to the second electroconductive member are spaced from each other in the predetermined direction, wherein the first electroconductive member has a first connecting terminal that is connected to an alternating-current current source, on an end portion of the first electroconductive member that is at a side in a spacing direction of the n number of capacitor elements; the second electroconductive member has a second connecting terminal that is connected to the alternating-current current source, on an end portion of the second electroconductive member that is at another side in the spacing direction of the n number of capacitor elements; the impedance of the first electroconductive member between the first connecting terminal and the ith (i is 1 to n) capacitor element from the first connecting terminal, and the impedance of the second electroconductive member between the second connecting terminal and the ith capacitor element, from the second connecting terminal are equal to each other; the impedance of the first electroconductive member between the (j+1)th (j is 1 to (n−2)) capacitor element and the (j+2)th capacitor element from the first connecting terminal is greater than the impedance of the first electroconductive member between the jth capacitor element and the (j+1)th capacitor element from the first connecting terminal; and the impedance of the second electroconductive member between the (j+1)th capacitor element and the (j+2)th capacitor element from the second connecting terminal is greater than the impedance of the second electroconductive member between the jth capacitor element and the (j+1)th capacitor element from the second connecting terminal.

The inventors of this application have found that the capacitor apparatus described above is able to restrain variations among the electric currents that flow through the capacitor elements. It is to be noted herein that in this capacitor apparatus, the aforementioned end portion of an electroconductive member which is provided with a connecting terminal means that no capacitor element is connected to the electroconductive member at an outer side of the connecting terminal in the spacing direction (predetermined direction) of the n number of capacitor elements, that is, the connecting terminal is not provided between capacitor elements, and the end portion of the electroconductive member does not need to be an extreme end portion of the electroconductive member.

Besides, in the foregoing capacitor apparatus, the impedance of the first electroconductive member between the (j+1)th capacitor element and the (j+2)th capacitor element from the first connecting terminal may be (j+1) times the impedance of the first electroconductive member between the first capacitor element and the second capacitor element from the first connecting terminal, and the impedance of the second electroconductive member between the (j+1)th capacitor element and the (j+2)th capacitor element from the second connecting terminal may be (j+1) times the impedance of the second electroconductive member between the first capacitor element and the second capacitor element from the second connecting terminal.

The inventors of this application have found that the foregoing capacitor apparatus is able to particularly effectively restrain variations among the electric currents that flow through the capacitor elements.

Besides, in the foregoing capacitor apparatus, portions of the first and second electroconductive members between the n number of capacitor elements may be different from each other in at least one of width, thickness and length.

According to the foregoing capacitor apparatus, in the first and second electroconductive members, the inductances between the capacitor elements can be changed to desired values, and the impedances between the capacitor elements can be changed to desired values.

Besides, in the foregoing capacitor apparatus, the inductance of each of the capacitor elements may be sufficiently smaller than the inductance of each of the first and second electroconductive members, and the alternating-current current source may be an alternating-current current source that supplies alternating-current current at a frequency such that the impedance of each of the first and second electroconductive members is sufficiently greater than the impedance of each of the capacitor elements.

The inventors of this application have found that the foregoing capacitor apparatus is able to particularly effectively restrain variations among the electric currents that flow through the capacitor elements.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1A is an illustrative diagram showing a general construction of a capacitor apparatus as an embodiment of the invention;

FIG. 1B is a plan view of a bus bar 20 which is taken from a direction y in FIG. 1A;

FIG. 1C is a plan view of a bus bar 30 which is taken from the direction y in FIG. 1A; and

FIG. 2 is a circuit diagram of the capacitor apparatus shown in FIG. 1A.

### DETAILED DESCRIPTION OF EMBODIMENTS

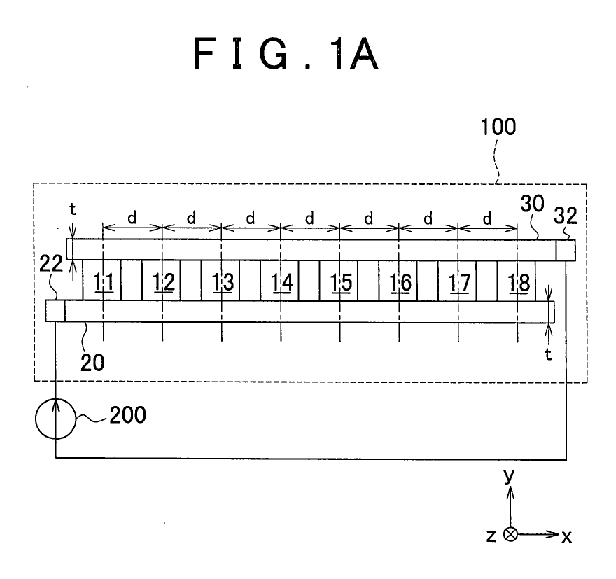

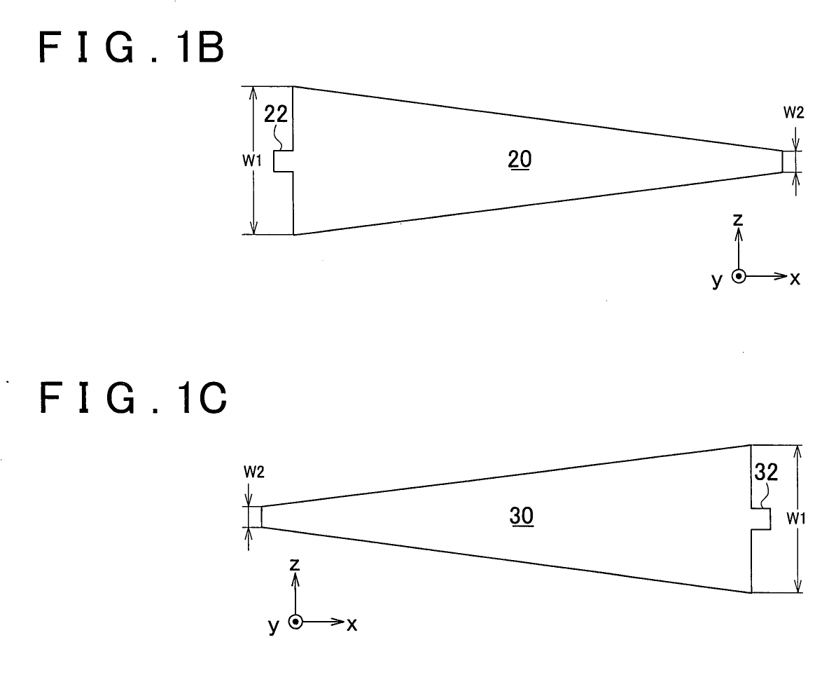

Embodiments of the invention will be described hereinafter with reference to the drawings. FIG. 1A is an illustrative diagram showing a general construction of a capacitor apparatus 100 as an embodiment of the invention. This capacitor apparatus 100 includes a plurality of capacitors that are connected in parallel to an alternating-current current source 200. Incidentally, although in this embodiment the number of capacitor elements provided is eight, the number of capacitor elements provided can be arbitrarily set according to the demanded electricity storage capacity.

As shown in FIG. 1A, the capacitor apparatus 100 includes the eight capacitor elements 11 to 18, a bus bar 20 that is an electroconductive member, and another bus bar 30 that is also an electroconductive member. The two electrodes of each of the capacitor elements 11 to 18 are connected to the bus bar 20 and to the bus bar 30, respectively. The electrodes of the capacitor elements 11 to 18 connected to the bus bar 20 and the electrodes thereof connected to the bus bar 30 are spaced from each other by intervals d in a lateral direction (direction x) in FIG. 1A. A left-side end portion of the bus bar 20 in the drawing is provided with a connecting terminal 22 that is connected to the alternating-current current source 200. Besides, a right-side end portion of the bus bar 30 in the drawing is provided with a connecting terminal 32 that is connected to the alternating-current current source 200. In this embodiment, the thicknesses t of the bus bars 20 and 30 are equal to each other.

FIG. 1B shows a plan view of the bus bar 20 that is taken from the direction y in FIG. 1A. Besides, FIG. 1C shows a plan view of the bus bar 30 that is taken from the direction y in FIG. 1A. As shown in FIG. 1B, the bus bar 20 has a trapezoidal shape whose longer base corresponds to a connecting terminal 22-side end portion of the bus bar 20, and whose shorter base corresponds to an end portion of the bus bar 20 that is opposite the connecting terminal 22. The length of the longer base of the bus bar 20 is W1, and the length of the shorter base thereof is W2. Besides, as shown in FIG. 1C, the bus bar 30 has a trapezoidal shape whose longer base corresponds to a connecting terminal 32-side end portion of the bus bar 30, and whose shorter base corresponds to an end portion of the bus bar 30 that is opposite the connecting terminal 32. The length of the longer base of the bus bar 30 is W1 and the length of the shorter base thereof is W2. In the capacitor apparatus 100 of this embodiment, since the bus bars 20 and 30 are given the foregoing shapes, the inductances of each of the bus bars 20 and 30 between the capacitor elements are made different from one another.

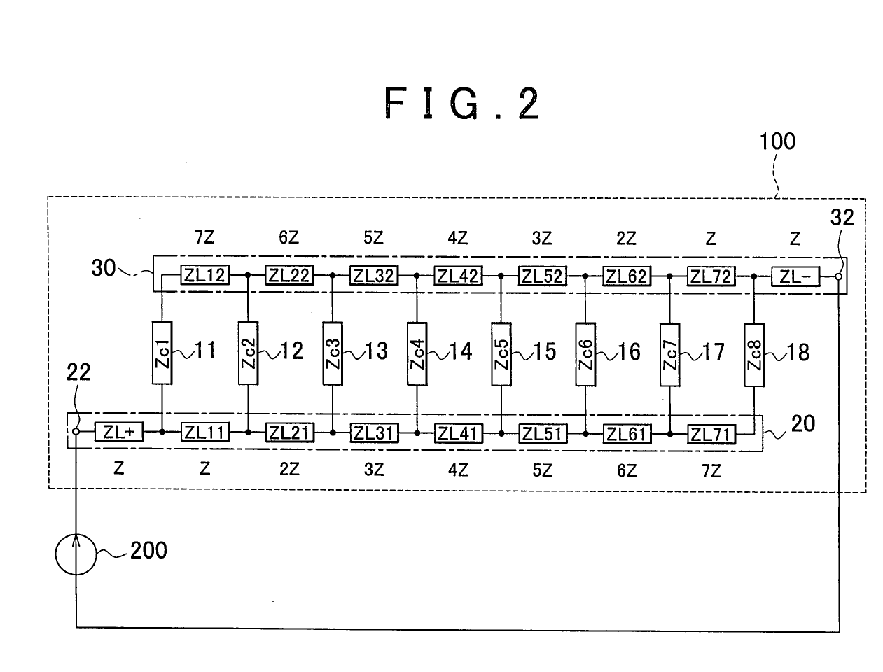

Next, the impedance of the bus bars will be described. FIG. 2 is a circuit diagram of the capacitor apparatus 100. In the capacitor apparatus 100, the impedance Zc1 of the capacitor element 11, the impedance Zc2 of the capacitor element 12, the impedance Zc3 of the capacitor element 13, the impedance Zc4 of the capacitor element 14, the impedance Zc5 of the capacitor element 15, the impedance Zc6 of the capacitor element 16, the impedance Zc7 of the capacitor element 17 and the impedance Zc8 of the capacitor element 18 are equal to one another. Incidentally, the inductance of the capacitor elements 11 to 18 is sufficiently smaller than the inductance of the bus bars 20 and 30. Besides, the alternating-current current source 200 is an alternating-current current source that supplies alternating-current current at such a frequency that the impedance of the bus bar 20 and the bus bar 30 is sufficiently greater than the impedance Zc1 to Zc8 of the capacitor elements 11 to 18.

Relations in impedance between various portions shown in FIG. 1A of the bus bar 20 and of the bus bar 30 are as follows. That is, in the bus bar 20, the impedance ZL+ between the connecting terminal 22 and the capacitor element 11 is Z. Besides, in the bus bar 20, the impedance ZL11 between the capacitor element 11 and the capacitor element 12 is Z. Besides, in the bus bar 20, the impedance ZL21 between the capacitor element 12 and the capacitor element 13 is 2Z. Besides, in the bus bar 20, the impedance ZL31 between the capacitor element 13 and the capacitor element 14 is 3Z. Besides, in the bus bar 20, the impedance ZL41 between the capacitor element 14 and the capacitor element 15 is 4Z. Besides, in the bus bar 20, the impedance ZL51 between the capacitor element 15 and the capacitor element 16 is 5Z. Besides, in the bus bar 20, the impedance ZL61 between the capacitor element 16 and the capacitor element 17 is 6Z. Besides, in the bus bar 20, the impedance ZL71 between the capacitor element 17 and the capacitor element 18 is 7Z.

That is, the impedance of the bus bar 20 between the (j+1)th (j is 1 to 6) capacitor element and the (j+2)th capacitor element from the connecting terminal 22 is (j+1) times the impedance ZL11 of the bus bar 20 between the first capacitor element 11 and the second capacitor element 12 from the connecting terminal 22.

Besides, in the bus bar 30, the impedance ZL12 between the capacitor element 11 and the capacitor element 12 is 7Z. Besides, in the bus bar 30, the impedance ZL22 between the capacitor element 12 and the capacitor element 13 is 6Z. Besides, in the bus bar 30, the impedance ZL32 between the capacitor element 13 and the capacitor element 14 is 5Z. Besides, in the bus bar 30, the impedance ZL42 between the capacitor element 14 and the capacitor element 15 is 4Z. Besides, in the bus bar 30, the impedance ZL52 between the capacitor element 15 and the capacitor element 16 is 3Z. Besides, in the bus bar 30, the impedance ZL62 between the capacitor element 16 and the capacitor element 17 is 2Z. In the bus bar 30, the impedance ZL72 between the capacitor element 17 and the capacitor element 18 is Z. Besides, in the bus bar 30, the impedance ZL− between the capacitor element 18 and the connecting terminal 32 is Z.

That is, the impedance of the bus bar 30 between the (j+1)th capacitor element and the (j+2)th capacitor element from the connecting terminal 32 is (j+1) times the impedance ZL72 of the bus bar 30 between the first capacitor element 18 and the second capacitor element 17 from the connecting terminal 32.

Besides, the impedance ZL+ of the bus bar 20 between the connecting terminal 22 and the capacitor element 11 is equal to the impedance ZL− of the bus bar 30 between the connecting terminal 32 and the capacitor element 18. Besides, the impedance ZL11 of the bus bar 20 between the capacitor element 11 and the capacitor element 12 is equal to the impedance ZL72 of the bus bar 30 between the capacitor element 18 and the capacitor element 17. Besides, the impedance ZL21 of the bus bar 20 between the capacitor element 12 and the capacitor element 13 is equal the impedance ZL62 of the bus bar 30 between the capacitor element 17 and the capacitor element 16. Besides, the impedance ZL31 of the bus bar 20 between the capacitor element 13 and the capacitor element 14 is equal to the impedance ZL52 of the bus bar 30 between the capacitor element 16 and the capacitor element 15. Besides, the impedance ZL41 of the bus bar 20 between the capacitor element 14 and the capacitor element 15 is equal to the impedance ZL42 of the bus bar 30 between the capacitor element 15 and the capacitor element 14. Besides, the impedance ZL51 of the bus bar 20 between the capacitor element 15 and the capacitor element 16 is equal to the impedance ZL32 of the bus bar 30 between the capacitor element 14 and the capacitor element 13. Besides, the impedance ZL61 of the bus bar 20 between the capacitor element 16 and the capacitor element 17 is equal to the impedance ZL22 of the bus bar 30 between the capacitor element 13 and the capacitor element 12. Besides, the impedance ZL71 of the bus bar 20 between the capacitor element 17 and the capacitor element 18 is equal to the impedance ZL12 of the bus bar 30 between the capacitor element 12 and the capacitor element 11.

That is, the impedance Z of the bus bar 20 between the ith (i is 1 to 8) capacitor element from the connecting terminal 22 and the connecting terminal 22, which is termed the impedance Z(i)22, is equal to the impedance of the bus bar 30 between the ith capacitor element from the connecting terminal 32 and the connecting terminal 32, which is termed the impedance Z(i)32. Since the relations among the impedances in the bus bars 20 and 30 are set as described above, the impedances from the connecting terminal 22 to the connecting terminal 32 through the capacitor elements 11 to 18 are equal to each other.

By the foregoing capacitor apparatus 100 of this embodiment, variations among the currents that flow through the capacitor elements 11 to 18 can be restrained. This has been found analytically and empirically by the inventors of this patent application.

Next, modifications of the embodiment will be described. While the embodiment of the invention has been described above, the invention is not limited by the foregoing embodiment in any manner, but can be carried out in various manners without departing from the spirit of the invention. For example, the following modifications are possible.

In the foregoing embodiment, the widths of the bus bars 20 and 30 between the capacitor elements 11 to 18 are varied so as to vary the inductances between the capacitor elements 11 to 18 and therefore vary the impedances therebetween. However, this does not limit the invention. That is, as Modification 1, the thicknesses of the bus bars 20 and 30 between the capacitor elements 11 to 18 or the lengths of the bus bars 20 and 30 between the capacitor elements 11 to 18 may be varied so as to vary the inductances between the capacitor elements 11 to 18 and therefore vary the impedances therebetween. That is, it may suffice to vary the impedances of the bus bars 20 and 30 between the capacitor elements 11 to 18 by providing variations among the portions of the bus bars 20 and 30 between the capacitor elements 11 to 18 in terms of at least one of the width, the thickness and the length of the bus bars 20 and 30. In this manner, in the bus bars 20 and 30, the inductances between the capacitor elements 11 to 18 can be changed to desired values and therefore the impedances between the capacitor elements 11 to 18 can be changed to desired values.

Although in the foregoing embodiment, the capacitor elements 11 to 18 are connected to the bus bars 20 and 30, this does not limit the invention. That is, as Modification 2, instead of the bus bars 20 and 30, it is permissible to use other electroconductive members, for example, metal foils (wiring) provided on a printed base board.

Although in the foregoing embodiment, the alternating-current current source 200 is an alternating-current current source that supplies alternating-current current at a frequency such that the impedance of the bus bar 20 and the bus bar 30 is sufficiently greater than the impedance Zc1 to Zc8 of the capacitor elements 11 to 18, this does not limit the invention. That is, as Modification 3, the capacitor apparatus 100 may be connected to an alternating-current current source that supplies alternating-current current at another frequency.

In the foregoing embodiment, the impedance of the bus bar 20 between the (j+1)th (j is 1 to 6) capacitor element and the (j+1)th capacitor element from the connecting terminal 22 is (j+1) times the impedance ZL11 of the bus bar 20 between the first capacitor element 11 and the second capacitor element 12 from the connecting terminal 22, and the impedance of the bus bar 30 between the (j+1)th capacitor element and the (j+2)th capacitor element from the connecting terminal 32 is (j+1) times the impedance ZL72 of the bus bar 30 between the first capacitor element 18 and the second capacitor element 17 from the connecting terminal 32. However, this does not limit the invention. That is, Modification 4 described below is also permissible.

That is, it is also permissible to adopt a construction in which the impedance of the bus bar 20 between the connecting terminal 22 and the ith (i is 1 to 8) capacitor element from the connecting terminal 22 is equal to the impedance of the bus bar 30 between the connecting terminal 32 and the ith capacitor element from the connecting terminal 32, and the impedance of the bus bar 20 between the (j+1)th (j is 1 to 6) capacitor element and the (j+2)th capacitor element from the connecting terminal 22 is greater than the impedance of the bus bar 20 between the jth capacitor element and the (j+1)th capacitor element from the connecting terminal 22, and the impedance of the bus bar 30 between the (j+1)th capacitor element and the (j+2)th capacitor element from the connecting terminal 32 is greater than the impedance of the bus bar 30 between the jth capacitor element and the (j+1)th capacitor element from the connecting terminal 32.

For example, in the construction shown in FIG. 2, it is permissible to have a setting of ZL11:ZL21:ZL31:ZL41:ZL51:ZL61:ZL71=ZL72:ZL62:ZL52:ZL42:ZL32:ZL22:ZL12=1/7:1/6:1/5:1/4:1/3:1/2:1. Besides, it is also permissible to have a setting of ZL11:ZL21:ZL31:ZL41:ZL51:ZL61:ZL71=ZL72:ZL62:ZL52:ZL42:ZL32:ZL22:ZL12=1:k²:k³:k⁴:k⁵:k⁶:k⁷ (k is a number greater than or equal to 1).

1. A capacitor apparatus comprising:
n number of capacitor elements each of which has a first electrode and a second electrode, where n is an integer that is greater than or equal to three;
a first electroconductive member to which the first electrodes of the n number of capacitor elements are connected, wherein the first electrodes of the n number of capacitor elements connected to the first electroconductive member are spaced from each other in a predetermined direction;
a second electroconductive member to which the second electrodes of the n number of capacitor elements are connected, wherein the second electrodes of the n number of capacitor elements connected to the second electroconductive member are spaced from each other in the predetermined direction, wherein
the first electroconductive member has a first connecting terminal that is connected to an alternating-current current source, on an end portion of the first electroconductive member that is at a side in a spacing direction of the n number of capacitor elements;
the second electroconductive member has a second connecting terminal that is connected to the alternating-current current source, on an end portion of the second electroconductive member that is at another side in the spacing direction of the n number of capacitor elements, and the shape of the first and second electroconductive member is chosen in such a way that the impedance of the first electroconductive member between the first connecting terminal and the ith (i is 1 to n) capacitor element from the first connecting terminal, and the impedance of the second electroconductive member between the second connecting terminal and the ith capacitor element from the second connecting terminal are equal to each other;
and the shape of the first and second electroconductive member is chosen in such a way that the impedance of the first electroconductive member between the (j+1)th (j is 1 to (n−2)) capacitor element and the (j+2)th capacitor element from the first connecting terminal is greater than the impedance of the first electroconductive member between the jth capacitor element and the (j+1)th capacitor element from the first connecting terminal; and
the shape of the first and second electroconductive member is chosen in such a way that the impedance of the second electroconductive member between the (j+1)th capacitor element and the (j+2)th capacitor element from the second connecting terminal is greater than the impedance of the second electroconductive member between the jth capacitor element and the (j+1)th capacitor element from the second connecting terminal.

2. The capacitor apparatus according to claim 1, wherein
the impedance of the first electroconductive member between the (j+1)th capacitor element and the (j+2)th capacitor element from the first connecting terminal is (j+1) times the impedance of the first electroconductive member between the first capacitor element and the second capacitor element from the first connecting terminal, and the impedance of the second electroconductive member between the (j+1)th capacitor element and the (j+2)th capacitor element from the second connecting terminal is (j+1) times the impedance of the second electroconductive member between the first capacitor element and the second capacitor element from the second connecting terminal.

3. The capacitor apparatus according to claim 1, wherein
portions of the first and second electroconductive members between the n number of capacitor elements are different from each other in at least one of width, thickness and length.

4. The capacitor apparatus according to claim 1, wherein
the inductance of each of the capacitor elements is sufficiently smaller than the inductance of each of the first and second electroconductive members, and the alternating-current current source is an alternating-current current source that supplies alternating-current current at a frequency such that the impedance of each of the first and second electroconductive members is sufficiently greater than the impedance of each of the capacitor elements.

5. The capacitor apparatus according to claim 1, wherein
the first and second electroconductive members have a trapezoidal shape, the longer base of which corresponds to the first and second connecting terminal end portion and the shorter base of which corresponds to the en d portion of the first and second electroconductive member.

6. The capacitor apparatus according to claim 1, wherein
the first and second electroconductive members are metal wires on a printed base board.

7. The capacitor apparatus according to claim 2, wherein
portions of the first and second electroconductive members between the n number of capacitor elements are different from each other in at least one of width, thickness and length.

8. The capacitor apparatus according to claim 2, wherein
the inductance of each of the capacitor elements is sufficiently smaller than the inductance of each of the first and second electroconductive members, and the alternating-current current source is an alternating-current current source that supplies alternating-current current at a frequency such that the impedance of each of the first and second electroconductive members is sufficiently greater than the impedance of each of the capacitor elements.

9. The capacitor apparatus according to claim 3, wherein
the inductance of each of the capacitor elements is sufficiently smaller than the inductance of each of the first and second electroconductive members, and the alternating-current current source is an alternating-current current source that supplies alternating-current current at a frequency such that the impedance of each of the first and second electroconductive members is sufficiently greater than the impedance of each of the capacitor elements.
